(19) United States
(12) Patent Application Publication
(10) Pub. No.: US 2005/0178600 A1
(43) Pub. Date: Aug. 18, 2005

(54) Integrated occupant and crash sensing control unit

(76) Inventor: Kevin D. Kincaid, Kokomo, IN (US)

Correspondence Address: STEFAN V. CHMIELEWSKI;DELPHI TECHNOLOGIES, INC., Legal Staff MC CT10C, P.O. Box 9005, Kokomo, IN, 46904-9005, US

(21) Appl. No.: 10/780,839

(22) Filed: Feb. 18, 2004

(51) Int. Cl. B60R 21/32

(52) U.S. Cl. 180/268; 280/735

(57) ABSTRACT

An integrated occupant and crash sensing control unit for a motor vehicle includes a first processor, a pressure sensor interface, a safety belt tension sensor interface and a dual axis accelerometer. The first processor provides an activation signal to a restraint device responsive to a pressure signal, a tension signal and lateral and longitudinal deceleration signals.

### TECHNICAL FIELD

The present invention is generally directed to crash sensing control units and occupant sensing control units and, more specifically, to an integrated occupant and crash sensing control unit.

### BACKGROUND OF THE INVENTION

Automotive airbags have been demonstrated to be effective in reducing fatalities in motor vehicle accidents. Unfortunately, in certain situations, airbags can cause serious injury to certain occupants who are in close proximity to an airbag when it deploys. The National Highway Traffic Safety Administration (NHTSA) has investigated and reported a total of 175 cases where airbag deployment has caused a fatality during the period from 1988 to 2000. In an effort to reduce airbag-related fatalities, new airbag systems have been developed to reduce the probability of airbag-induced injury.

In general, these airbag systems may incorporate suppression of airbag deployment or reduce airbag deployment force in certain situations. Typically, airbag system implementations include some form of occupant classification capability, which suppresses airbag deployment when small children or infants are detected. One known technique for performing occupant classification has measured the amount of force that an occupant of a seat transmits through a seat cushion and, thus, classifies the occupant-type based on the transmitted force.

In one airbag system, a silicone filled bladder is positioned within a seat cushion of a seat. In this configuration, the bladder is connected to a pressure sensor, which is in turn connected to an occupant sensing control unit. When the occupant sits in the seat, the bladder is compressed, resulting in an increase in pressure, which is measured by the pressure sensor and typically transmitted as an analog voltage signal to the occupant sensing control unit. The occupant sensing control unit then compares the signal to a predetermined threshold to determine whether to enable airbag deployment. Pressures above a given threshold are classified as an allow airbag deployment condition and pressures below the threshold are classified as an inhibit airbag deployment condition.

Various airbag systems have also used a seat belt tension sensor in conjunction with the pressure sensor. The belt tension sensor is included to compensate for pressure increases caused by the seat belt system. In a typical airbag system, an occupant classification message is transmitted over a serial communication bus to a crash sensing control unit, which enables or disables deployment of the airbag based upon the received message.

As discussed above, currently, automotive manufacturers have utilized multiple electronic control units that are partitioned into individual functions, i.e., an occupant sensing function and a crash sensing function. In such automotive systems, one unit performs the occupant classification function and a second unit performs a crash sensing function. The second unit enables or disables deployment of the airbag, based upon the occupant classification received as a serial data message from the first control unit. It should be appreciated that such a system is relatively inefficient as many design components are duplicated in each control unit.

What is needed is an integrated occupant and crash sensing control unit for a motor vehicle that provides a more efficient design. Further, it would be desirable for an integrated occupant and crash sensing control unit to have a smaller package size, reduced mass, a lower number of system interconnections and a lower overall cost, as compared to an aggregate of individual control units.

### SUMMARY OF THE INVENTION

An integrated occupant and crash sensing control unit for a motor vehicle includes a first processor, a pressure sensor interface, a safety belt tension sensor interface and a dual axis accelerometer. The pressure sensor interface is coupled between the first processor and a pressure sensor. The pressure sensor provides a pressure signal, which provides an indication of a weight of an occupant of a seat of a motor vehicle, to the first processor. The safety belt tension sensor interface is coupled between the first processor and a safety belt tension sensor, which provides a tension signal to the first processor. The tension signal provides an indication of a tension within a safety belt associated with the seat.

The dual axis accelerometer is coupled to the first processor and provides a lateral deceleration signal and a longitudinal deceleration signal to the first processor. The lateral and longitudinal deceleration signals provide an indication of the lateral and longitudinal deceleration, respectively, of the motor vehicle. The first processor provides an activation signal to a restraint device responsive to the pressure signal, the tension signal and the lateral and longitudinal deceleration signals.

According to another embodiment of the present invention, the integrated occupant and crash sensing control unit includes a remote crash sensor interface that is coupled between the first processor and a remote crash sensor. The remote crash sensor provides a crash signal, which indicates whether the motor vehicle has experienced a collision, to the first processor. The first processor provides an activation signal to a restraint device responsive to the pressure signal, the tension signal, the lateral and longitudinal deceleration signals and the crash signal.

According to another aspect of the present invention, the control unit includes a second processor coupled to the dual axis accelerometer. The second processor provides an override signal that prevents the activation signal from activating the restraint device when the second processor determines that the lateral and longitudinal deceleration signals indicate that deployment of the restraint device is not warranted.

According to another embodiment of the present invention, the second processor is coupled to the dual axis accelerometer and the remote crash sensor interface. In this embodiment, the second processor provides an override signal that prevents the activation signal from activating the restraint device when the lateral and longitudinal deceleration signals and the crash signal indicate that deployment of the restraint device is not warranted.

According to another embodiment of the present invention, a control unit includes a rollover sensor coupled to the first processor. The rollover sensor includes an angular rate sensor and a vertical accelerometer for measuring an angular acceleration and a vertical acceleration, respectively, of the motor vehicle. In this embodiment, the first processor also provides the activation signal responsive to the angular and vertical accelerations of the motor vehicle. According to a different aspect of the invention, the rollover sensor is coupled to the first and second processors and includes an angular rate sensor and a vertical accelerometer for measuring an angular acceleration and a vertical acceleration, respectively, of the motor vehicle. In this embodiment, the first processor also provides the activation signal responsive to the angular and vertical accelerations of the motor vehicle and the second processor also provides the override signal responsive to the angular and vertical accelerations of the motor vehicle. According to another embodiment of the present invention, the restraint device is an airbag.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of an exemplary occupant sensing control unit;

FIG. 2 is a block diagram of an exemplary crash sensing control unit; and

FIG. 3 is a block diagram of an integrated occupant and crash sensing control unit for a motor vehicle, according to an embodiment of the present invention.

### DESCRIPTION OF THE PREFERRED EMBODIMENTS

According to the present invention, an integrated occupant and crash sensing control unit for a motor vehicle is provided in an efficient design that requires less vehicle packaging space, offers a reduced mass, has a lower number of system interconnections, with a corresponding increase in system reliability, and provides for a lower overall system cost.

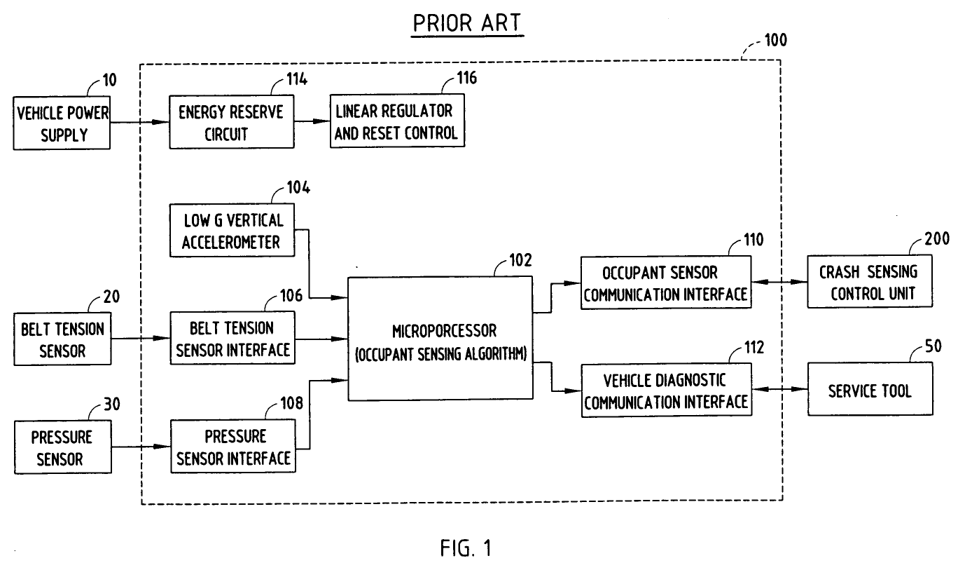

FIG. 1 depicts an electrical block diagram of an exemplary occupant sensing control unit 100, according to the prior art. As is shown in FIG. 1, control unit 100 includes an energy reserve circuit 114, which receives power from a vehicle power supply 10, that is coupled to a linear regulator and reset control circuit 116. The energy reserve circuit 114 maintains operation of the control unit 100 for a specified period of time after loss of vehicle power and the linear regulator and reset control circuit 116 provides operating voltage for the components of the control unit 100. A microprocessor 102 implements an occupant sensing algorithm that utilizes information received from a belt tension sensor 20, via a belt tension sensor interface 106, and a pressure sensor 30, via a pressure sensor interface 108, and vertical accelerometer 104, e.g., a low G vertical accelerometer. The microprocessor 102 also communicates with a crash sensing control unit 200, via an occupant sensor communication interface 110, and may also communicate with a service tool 50, via a vehicle diagnostic communication interface 112. The occupant sensing algorithm utilizes a belt tension signal, a pressure signal and a deceleration signal to classify an occupant, e.g., as an adult, small child or infant, of a seat of a motor vehicle.

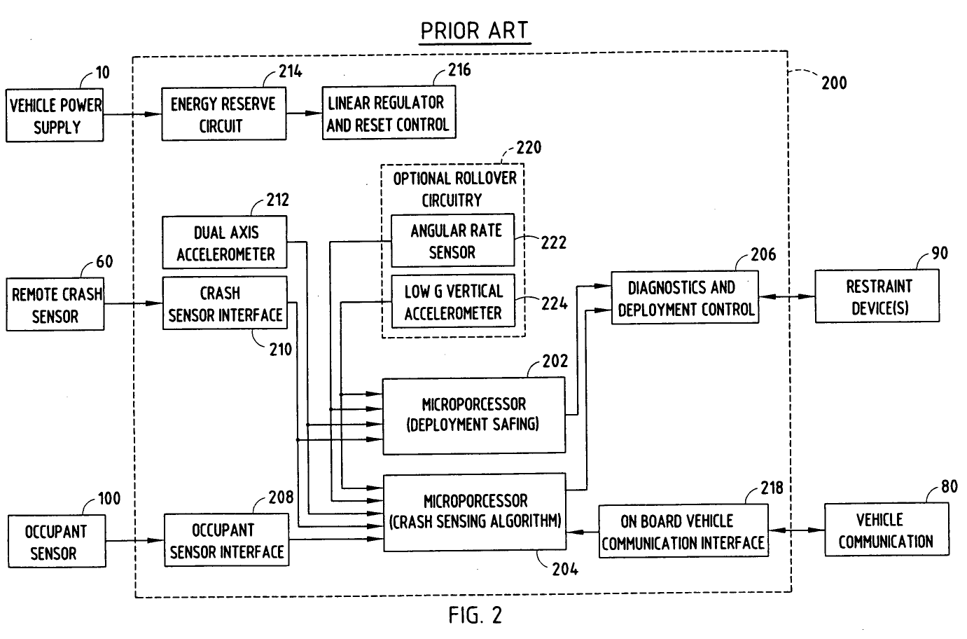

With reference to FIG. 2, the crash sensing control unit 200 is further depicted in block diagram form. Similar to the occupant sensing control unit 100, the control unit 200 includes an energy reserve circuit 214 and a linear regulator and reset control circuit 216, both of which receive power from a vehicle power source 10. As is shown in FIG. 2, a microprocessor 204, which implements a crash sensing algorithm, is coupled to the occupant sensing control unit 100, via an occupant sensor communication interface 208. The microprocessor 204 is also coupled to a remote crash sensor 60, via a crash sensor interface 210, and a dual axis accelerometer 212. The microprocessor 204 may also be coupled to a rollover circuit 220, which includes an angular rate sensor 222 and a vertical accelerometer 224.

As is shown in FIG. 2, the control unit 200 also includes a second microprocessor 202, which is utilized for deployment safing. That is, the microprocessor 202 provides a redundant processing path to prevent a single point failure from resulting in inadvertent airbag deployment. Inputs of the microprocessor 202 are coupled to the optional rollover circuitry 220, the dual axis accelerometer 212 and the remote crash sensor 60, via the crash sensor interface 210. Outputs of the microprocessors 202 and 204 are coupled to a diagnostic and deployment control circuit 206, which determines whether a deployment signal is sent to the restraint device 90, e.g., an airbag. The dual axis accelerometer 212 monitors the lateral and longitudinal motor vehicle deceleration and transmits the information to the microprocessor 204, which utilizes the information in the crash sensing algorithm. This information may also be supplemented by information received from the remote crash sensor 60, via the crash sensor interface 210. When the crash sensing algorithm, executed by the microprocessor 204, indicates that the vehicle acceleration is severe enough to warrant activation of the restraint device 90, the microprocessor 204 sends the appropriate control stimulus to the deployment control circuit, located within diagnostic and deployment control circuit 206. As previously stated, the microprocessor 202 provides a redundant processing path to determine whether the restraint device 90 should, in fact, be deployed.

The microprocessor 204 receives occupant classification information from the occupant sensor control unit 100, via the occupant sensor communication interface 208. In the event that the occupant classification information indicates that the airbag deployment should be suppressed, i.e., an infant or small child is detected, the microprocessor 204 suppresses deployment of the restraint device 90. The microprocessor 204 may also utilize information obtained from the rollover circuitry 210. As is shown in FIG. 2, the microprocessor 204 may also communicate with devices coupled to a vehicle communication bus 80, via an onboard vehicle communication interface 218, and may also communicate with a service tool (not shown in FIG. 2) for diagnostic purposes over the communication bus 80.

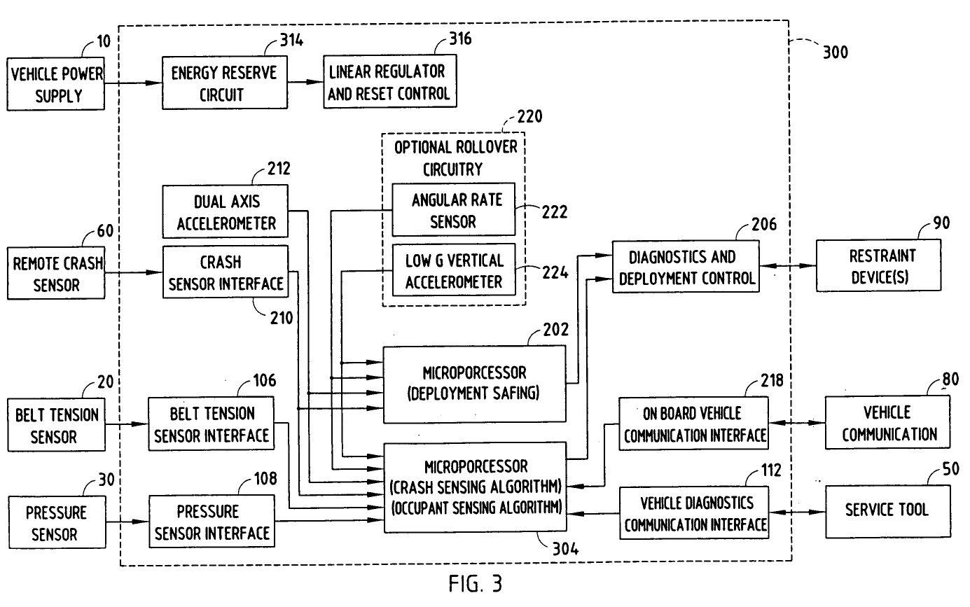

According to one embodiment of the present invention, as is depicted in FIG. 3, an integrated occupant and crash sensing control unit 300 includes an energy reserve circuit 314 and a linear regulator and reset control circuit 316, both of which receive power from the vehicle power source 10. A microprocessor 304 implements both a crash sensing algorithm and an occupant sensing algorithm. As shown, the microprocessor 304 receives input from a dual axis accelerometer 212, a remote crash sensor 60 (via a crash sensor interface 210), the belt tension sensor 20 (via a belt tension sensor interface 106) and the pressure sensor 30 (via the pressure sensor interface 108). The microprocessor 304 may also receive angular rate information from the angular rate sensor 222 and vertical deceleration from the vertical accelerometer 224, both of which may be included within the rollover circuit 220. As with the embodiment of FIG. 2, the microprocessor 202 also provides deployment safing. The microprocessor 304 is also coupled to the onboard vehicle communication interface 218, which allows the control unit 300 to communicate with devices coupled to the vehicle communication bus 80. Additionally, the microprocessor 304 may communicate with the service tool 50, via the vehicle diagnostic communication interface 112. As discussed in conjunction with FIG. 2, the microprocessor 304 may provide a deployment signal to the diagnostic and deployment circuit 206, which provides a deployment signal to the restraint device 90 providing that the microprocessor 202 also indicates that the restraint device 90 should be deployed.

Accordingly, an integrated occupant and crash sensing control unit for a motor vehicle has been described herein that utilizes many common blocks previously implemented in multiple control units. For example, the power supply circuitry is no longer duplicated and a single microprocessor implements both a crash sensing algorithm and an occupant sensing algorithm. Further, it should be appreciated that redundancy in the mechanical aspects of the packaging of an integrated control unit is reduced as a single case cover, circuit board and connector interface may be utilized for a multi-function control unit configured according to the present invention.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. An integrated occupant and crash sensing control unit for a motor vehicle, comprising:
a first processor;
a pressure sensor interface coupled between the first processor and a pressure sensor, wherein the pressure sensor provides a pressure signal to the first processor, the pressure signal providing an indication of a weight of an occupant of a seat of a motor vehicle;
a safety belt tension sensor interface coupled between the first processor and a safety belt tension sensor, wherein the belt tension sensor provides a tension signal to the first processor, the tension signal providing an indication of a tension within a safety belt associated with the seat; and
a dual axis accelerometer coupled to the first processor, wherein the accelerometer provides a lateral deceleration signal and a longitudinal deceleration signal to the first processor, the lateral and longitudinal deceleration signals providing an indication of the lateral and longitudinal deceleration, respectively, of the motor vehicle, and wherein the first processor provides an activation signal to a restraint device responsive to the pressure signal, the tension signal and the lateral and longitudinal deceleration signals.

2. The control unit of claim 1, further including:
a remote crash sensor interface coupled between the first processor and a remote crash sensor, wherein the remote crash sensor provides a crash signal to the first processor, the crash signal indicating whether the motor vehicle has experienced a collision, and wherein the first processor provides an activation signal to the restraint device responsive to the pressure signal, the tension signal, the lateral and longitudinal deceleration signals and the crash signal.

3. The control unit of claim 1, further including:
a second processor coupled to the dual axis accelerometer, the second processor providing an override signal that prevents the activation signal from activating the restraint device when the second processor determines that the lateral and longitudinal deceleration signals indicate that deployment of the restraint device is not warranted.

4. The control unit of claim 2, further including:
a second processor coupled to the dual axis accelerometer and the remote crash sensor interface, the second processor providing an override signal that prevents the activation signal from activating the restraint device when the lateral and longitudinal deceleration signals and the crash signal indicate that deployment of the restraint device is not warranted.

5. The control unit of claim 1, further including:
a rollover sensor coupled to the first processor, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle.

6. The control unit of claim 3, further including:
a rollover sensor coupled to the first and second processors, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle, and wherein the second processor also provides the override signal responsive to the angular and vertical accelerations of the motor vehicle.

7. The control unit of claim 1, wherein the restraint device is an airbag.

8. An integrated occupant and crash sensing control unit for a motor vehicle, comprising:
a first processor;
a pressure sensor interface coupled between the first processor and a pressure sensor, wherein the pressure sensor provides a pressure signal to the first processor, the pressure signal providing an indication of a weight of an occupant of a seat of a motor vehicle;
a safety belt tension sensor interface coupled between the first processor and a safety belt tension sensor, wherein the belt tension sensor provides a tension signal to the first processor, the tension signal providing an indication of a tension within a safety belt associated with the seat; and
a dual axis accelerometer coupled to the first processor, wherein the accelerometer provides a lateral deceleration signal and a longitudinal deceleration signal to the first processor, the lateral and longitudinal deceleration signals providing an indication of the lateral and longitudinal deceleration, respectively, of the motor vehicle, and wherein the first processor provides an activation signal to an airbag responsive to the pressure signal, the tension signal and the lateral and longitudinal deceleration signals.

9. The control unit of claim 8, further including:
a remote crash sensor interface coupled between the first processor and a remote crash sensor, wherein the remote crash sensor provides a crash signal to the first processor, the crash signal indicating whether the motor vehicle has experienced a collision, and wherein the first processor provides an activation signal to the airbag responsive to the pressure signal, the tension signal, the lateral and longitudinal deceleration signals and the crash signal.

10. The control unit of claim 8, further including:
a second processor coupled to the dual axis accelerometer, the second processor providing an override signal that prevents the activation signal from activating the airbag when second processor determines that the lateral and longitudinal deceleration signals indicate that deployment of the airbag is not warranted.

11. The control unit of claim 9, further including:
a second processor coupled to the dual axis accelerometer and the remote crash sensor interface, the second processor providing an override signal that prevents the activation signal from activating the airbag when the lateral and longitudinal deceleration signals and the crash signal indicate that deployment of the airbag is not warranted.

12. The control unit of claim 8, further including:
a rollover sensor coupled to the first processor, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle.

13. The control unit of claim 10, further including:
a rollover sensor coupled to the first and second processors, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle, and wherein the second processor also provides the override signal responsive to the angular and vertical accelerations of the motor vehicle.

14. An integrated occupant and crash sensing control unit for a motor vehicle, comprising:
a first processor;
a pressure sensor interface coupled between the first processor and a pressure sensor, wherein the pressure sensor provides a pressure signal to the first processor, the pressure signal providing an indication of a weight of an occupant of a seat of a motor vehicle;
a safety belt tension sensor interface coupled between the first processor and a safety belt tension sensor, wherein the belt tension sensor provides a tension signal to the first processor, the tension signal providing an indication of a tension within a safety belt associated with the seat;
a dual axis accelerometer coupled to the first processor, wherein the accelerometer provides a lateral deceleration signal and a longitudinal deceleration signal to the first processor, the lateral and longitudinal deceleration signals providing an indication of the lateral and longitudinal deceleration, respectively, of the motor vehicle, and wherein the first processor provides an activation signal to a restraint device responsive to the pressure signal, the tension signal and the lateral and longitudinal deceleration signals; and
an energy reserve circuit coupled to the first processor, the pressure sensor interface, the belt tension sensor interface and the dual axis accelerometer, wherein the energy reserve circuit provides power to the first processor, the pressure sensor interface, the belt tension sensor interface and the dual axis accelerometer for a limited period of time following a collision.

15. The control unit of claim 14, further including:
a remote crash sensor interface coupled between the first processor and a remote crash sensor, wherein the remote crash sensor provides a crash signal to the first processor, the crash signal indicating whether the motor vehicle has experienced a collision, and wherein the first processor provides an activation signal to the restraint device responsive to the pressure signal, the tension signal, the lateral and longitudinal deceleration signals and the crash signal.

16. The control unit of claim 14, further including:
a second processor coupled to the dual axis accelerometer, the second processor providing an override signal that prevents the activation signal from activating the restraint device when second processor determines that the lateral and longitudinal deceleration signals indicate that deployment of the restraint device is not warranted.

17. The control unit of claim 15, further including:
a second processor coupled to the dual axis accelerometer and the remote crash sensor interface, the second processor providing an override signal that prevents the activation signal from activating the restraint device when the lateral and longitudinal deceleration signals and the crash signal indicate that deployment of the restraint device is not warranted.

18. The control unit of claim 14, further including:
a rollover sensor coupled to the first processor, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle.

19. The control unit of claim 16, further including:
a rollover sensor coupled to the first and second processors, the rollover sensor including an angular rate sensor and a vertical accelerometer for measuring an angular acceleration and a vertical acceleration, respectively, of the motor vehicle, wherein the first processor also provides the activation signal responsive to the angular and vertical accelerations of the motor vehicle, and wherein the second processor also provides the override signal responsive to the angular and vertical accelerations of the motor vehicle.

20. The control unit of claim 14, wherein the restraint device is an airbag.
